(19) United States
(12) Patent Application Publication
(10) Pub. No.: US 2016/0180520 A1
(43) Pub. Date: Jun. 23, 2016

(54) QUANTITATIVE METHOD FOR 3-D JOINT CHARACTERIZATION

(71) Applicant: Carestream Health, Inc., Rochester, NY (US)

(72) Inventors: Zhimin Huo, Pittsford, NY (US); William J. Sehnert, Fairport, NY (US); Mingming Kong, Shanghai (CN); Andre Souza, Webster, NY (US)

(21) Appl. No.: 14/969,332

(22) Filed: Dec. 15, 2015

Related U.S. Application Data
(60) Provisional application No. 62/093,119, filed on Dec. 17, 2014.

(51) Int. Cl. G06T 7/00; G06T 15/08; G06T 19/20; G06T 11/20

(52) U.S. Cl. CPC G06T 7/0012; G06T 7/0081; G06T 11/206; G06T 15/08; G06T 19/20; G06T 2207/30008; G06T 2207/20144; G06T 2215/16; G06T 2219/004; G06T 2207/10081; G06T 2207/10088; G06T 2207/20092

(57) ABSTRACT

A method for characterizing a bone joint of a patient, the method executed at least in part by a computer, accesses 3-D volume image content that includes the bone joint and automatically segments the bone joint volume image content from background content to define at least a first bone surface and a second bone surface that is spaced apart from and faces the first bone surface. One or more distances between at least a first point on the first bone surface and one or more points on the second bone surfaces are computed. The method displays at least the first and second bone surfaces, wherein the display appearance is conditioned by the one or more computed distances. The method displays, stores, or transmits data relating to the one or more computed distances.

### CROSS REFERENCE TO RELATED APPLICATIONS

This application claims the benefit of U.S. Provisional application U.S. Ser. No. 62/093,119, provisionally filed on Dec. 17, 2014, entitled “QUANTITATIVE METHOD FOR 3-D JOINT SPACE ANALYSIS VISUALIZATION AND MONITORING”, in the names of Andre Souza et al., incorporated herein in its entirety.

### TECHNICAL FIELD

The disclosure relates generally to diagnostic imaging and in particular to methods and apparatus for characterization of bone joint structure and condition.

### BACKGROUND

Joint damage in arthritis (such as osteoarthritis and rheumatoid arthritis (RA)) can result in functional impairment, disability, and overall mobility loss. Analysis from trial data has demonstrated that joint space narrowing, rather than erosive damage, is associated with an irreversible decline in physical function over time. Joint space narrowing has been largely ignored as a sign of progression of disease in comparison to erosion development, but is clearly of significant importance for improved diagnosis and care.

Current scoring methods for joint space narrowing using conventional radiographs are characterized by inaccuracy and relative insensitivity to change. In one widely used scoring system in randomized clinical trials in RA, an ordinal scale is used to characterize normal joint space, minimal narrowing, generalized narrowing with either <50% or >50% of the joint space remaining, or complete loss of joint space. Ordinal scales characterize incremental steps in change, but may miss small continuous measurements that represent progression. To address this, methods to directly measure the joint space width using 2-D radiography or using a variety of automated software programs have been described. Additionally, joint space width measurements have been determined using digital X-ray radiogrammetry (DXR), a technology more traditionally used in measuring bone mineral density in the hand. These techniques attempt to determine the measurement using a 2 dimensional image, and, at least in part due to the complexities of joint structure, can be subject to projection errors, discrepancies related to joint position, and obscured or damaged joint margins. Alternate imaging technologies that can be used for obtaining volume image data content include magnetic resonance imaging (MRI) and ultrasound.

In an attempt to measure joint space width measures quantitatively, sensitive tools that reliably characterize the bone and related tissue interface at the joint are desired. Conventional 2D radiography and other methods have provided some help for bone joint characterization, but fall short of what is needed for effectively visualizing and quantifying joint condition in order to provide accurate biometric data or providing any type of biomarker that is indicative of conditions such as ageing, bone loss, disease, damage, or infection.

Volume or 3D imaging methods such as computed tomography (CT) such as cone-beam computed tomography (CBCT) can be useful tools for imaging bone, with CT viewed as superior for detecting erosive changes and for providing more detailed information related to bone surfaces. High-resolution peripheral quantitative computed tomography is an instrument capable of imaging bones and can provide a high degree of accuracy for quantitative assessment for bone and joint condition. However, the diagnostician and clinician need tools and utilities for more accurate characterization of joint condition and that can allow standardization and quantification of factors related to joint health for long-term monitoring as well as immediate care functions.

The Applicants desire to improve the methodology to more accurately characterize joint spacing using volume imaging techniques.

### SUMMARY

Certain embodiments described herein address the need for a method for characterizing joint condition of a patient. This characterization can provide improved visualization and metrics that relate to distance and pressure information for localized joint areas as well as provide more global information related to the joint surface and interface volumes as indicators for the joint health.

Another aspect of the present disclosure is to display, store, or transmit imagery that characterizes joint spacing of a patient.

According to at least one aspect of the invention, there is described a method for characterizing bone joint spacing of a patient, the method executed at least in part by a computer. The method includes: accessing a 3-D volume image that includes at least bone content and background; automatically segmenting a 3-D bone region from the 3-D volume image to generate a 3-D bone volume image having a plurality of voxels and at least one joint; automatically computing, from the 3-D bone volume image, a 3-D distance map image of the at least one joint; computing one or more joint spacing parameters of the at least one joint from the 3-D distance map image; and displaying, storing, or transmitting the one or more joint spacing parameters.

According to another aspect of the invention, there is provided a method for characterizing a bone joint of a patient, the method executed at least in part by a computer and comprising: accessing 3-D volume image content that includes the bone joint; automatically segmenting the bone joint volume image content from background content to define at least a first bone surface and a second bone surface that is spaced apart from and faces the first bone surface; computing one or more distances between at least a first point on the first bone surface and one or more points on the second bone surfaces; displaying at least the first and second bone surfaces, wherein the display appearance is conditioned by the one or more computed distances; and displaying, storing, or transmitting data relating to the one or more computed distances.

These aspects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1A is a perspective schematic view that shows a volume imaging apparatus used for volume imaging of an extremity.

FIG. 1B is a schematic diagram showing a test setup for obtaining measurements relating bone distance to pressure.

FIG. 1C shows a knee joint used for pressure measurement, as displayed from volume image content.

FIG. 1D is a plan view that shows a visualization of the measured pressure data that can be obtained from a transducer measuring bone joint pressure.

FIG. 2 shows a graph that relates joint distance to pressure as a first-order approximation.

FIG. 3 shows a processing sequence for generating a joint space analysis mapping.

FIG. 4 shows an exemplary distance map for a portion of a bone joint.

FIG. 5 shows an exemplary display of joint spacing analysis results.

FIG. 6A is a schematic diagram that shows a number of distance metrics for bone joint analysis.

FIG. 6B shows additional sliding force vector that can be a factor for pressure characterization.

FIG. 7 shows a weighting scheme that applies different weights or strengths to the overall pressure contribution onto a surface from a set of nearby points on a facing surface.

FIG. 8 is a logic flow diagram that shows a sequence characterizing a bone joint of a patient.

FIGS. 9A, 9B, 9C, 9D, 9E, 9F, 9G, 9H, and 9I show additional features of an operator interface for segmentation, labeling, and generating various distance and pressure data from volume images of a bone joint.

FIG. 10A shows highlighting of a displayed surface according to a distance map.

FIG. 10B shows segmentation and volume display of the space between joints available according to an embodiment of the present disclosure.

FIG. 10C shows an unfolded view of a joint automatically generated by the system according to an embodiment of the present disclosure.

FIG. 11A is a schematic diagram that shows a side-by-side display for comparison of the patient with image content obtained previously.

FIG. 11B is a schematic diagram that shows a multi-window display for viewing multiple images and associated data related to bone joint characterization.

FIG. 11C is a schematic diagram that shows an exemplary side-by-side display for weight-bearing and non-weight-bearing conditions.

FIG. 12 is a logic flow diagram that shows a sequence for using a template and scoring procedure for bone joint display and characterization.

### DETAILED DESCRIPTION OF THE EMBODIMENTS

The following is a detailed description of the embodiments of the invention, reference being made to the drawings in which the same reference numerals identify the same elements of structure in each of the several figures.

Where they are used in the context of the present disclosure, the terms “first”, “second”, and so on, do not necessarily denote any ordinal, sequential, or priority relation, but are simply used to more clearly distinguish one step, element, or set of elements from another, unless specified otherwise.

As used herein, the term “energizable” relates to a device or set of components that perform an indicated function upon receiving power and, optionally, upon receiving an enabling signal.

In the context of the present disclosure, the phrase “in signal communication” indicates that two or more devices and/or components are capable of communicating with each other via signals that travel over some type of signal path. Signal communication may be wired or wireless. The signals may be communication, power, data, or energy signals. The signal paths may include physical, electrical, magnetic, electromagnetic, optical, wired, and/or wireless connections between the first device and/or component and second device and/or component. The signal paths may also include additional devices and/or components between the first device and/or component and second device and/or component.

In the context of the present disclosure, the term “extremity” has its meaning as conventionally understood in diagnostic imaging parlance, referring to knees, legs, ankles, fingers, hands, wrists, elbows, arms, and shoulders and any other anatomical extremity. The term “subject” is used to describe the extremity of the patient that is imaged, such as the “subject leg”, for example. The term “paired extremity” is used in general to refer to any anatomical extremity wherein normally two or more are present on the same patient. In the context of the present invention, the paired extremity is not imaged; only the subject extremity is imaged.

To describe an embodiment of the present disclosure in detail, the examples given herein focus on imaging of the load-bearing lower extremities of the human anatomy, such as the hip, the leg, the knee, the ankle, and the foot, for example. However, these examples are considered to be illustrative and non-limiting. The imaging and measurement methods of the present disclosure can similarly be applied for joints that may not be considered as load-bearing. Moreover, different metrics can be provided for the same joint under load-bearing and non-load-bearing conditions, as described in more detail subsequently.

In the context of the present disclosure, the term “arc” or, alternately, “circular arc”, has its conventional meaning as being a portion of a circle of less than 360 degrees or, considered alternately, of less than 2π radians for a given radius.

In the context of the present disclosure, “volume image”, “volume image content” or “3D volume image” describes the reconstructed image data for an imaged subject, generally generated and stored as a set of voxels derived from measurements of density to radiation energy. Image display utilities use the volume image content in order to display features within the volume, selecting specific voxels that represent the volume content for a particular slice or view of the imaged subject. Thus, volume image content is the body of resource information that is obtained from a CBCT or other volume imaging reconstruction process and that can be used to generate depth visualizations of the imaged subject. The 3-D volume image can be obtained from a volume imaging apparatus such as a CT (computed tomography), CBCT (cone beam computed tomography), and/or MRI (magnetic resonance imaging) system, for example.

In the context of the present disclosure, the term “bone joint” is used to include the combined skeletal structures, including bone mineral density (BMD) that can be imaged and calculated using the radiation energy of CT, CBCT or other volume imaging system using well-known techniques. The bone joint is associated with cartilage and connective tissue at the bone interface, that cooperate to provide joint function and movement. Unless specifically stated otherwise, the term “bone surface” does not include cartilaginous tissues that form a portion of the mating surfaces at the joint. Measurements obtained using an embodiment of the present disclosure can characterize features of the cartilaginous tissue, such as depth or width and overall volume, but do not directly image the cartilage that lies within and cooperates with the bone joint.

The term “highlighting” for a displayed feature has its conventional meaning as is understood to those skilled in the information and image display arts. In general, highlighting uses some form of localized display enhancement to attract the attention of the viewer. Highlighting a portion of an image, such as an individual organ, bone, or structure, or a path from one chamber to the next, for example, can be achieved in any of a number of ways, including, but not limited to, annotating, displaying a nearby or overlaying symbol, outlining or tracing, display in a different color or at a markedly different intensity or gray scale value than other image or information content, blinking or animation of a portion of a display, or display at higher sharpness or contrast.

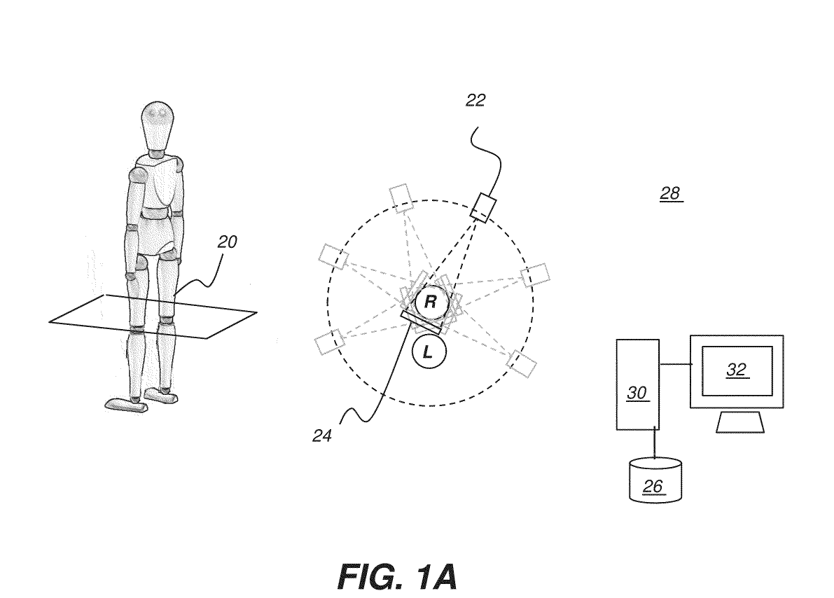

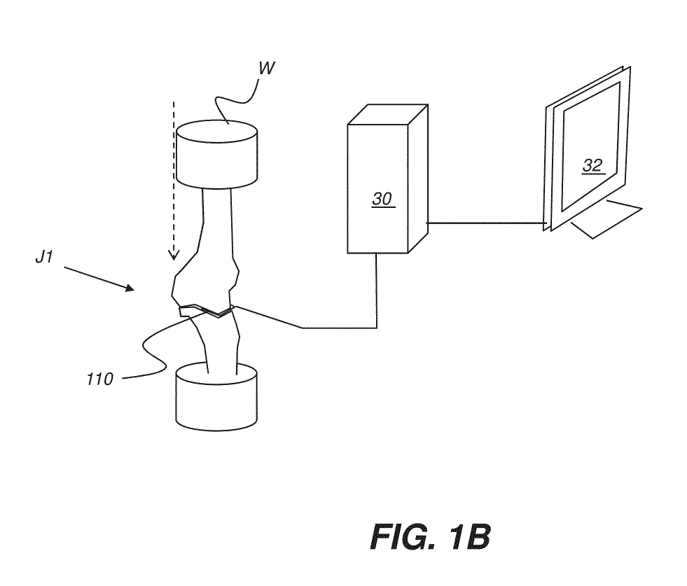

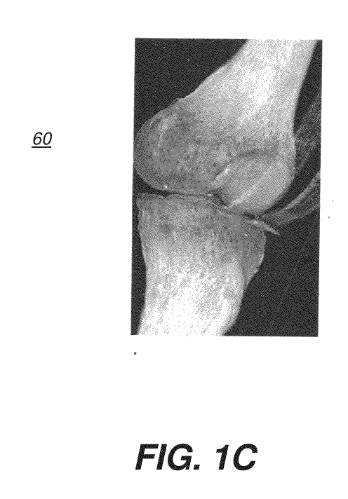

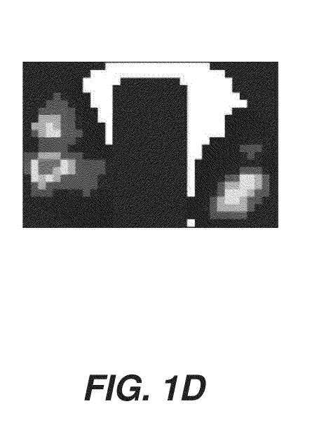

The perspective schematic view of FIG. 1A shows a volume imaging apparatus 28 used for CBCT imaging of an extremity, with the circular scan paths for a radiation source 22 and detector 24 when imaging the right knee R of a patient as a subject 20. Various positions of radiation source 22 and detector 24 are shown in dashed line form. Source 22, placed at some distance from the knee, can be positioned at different points over an arc of about 200 degrees, constrained where left knee L blocks the way. Detector 24, a digital radiography (DR) detector that is smaller than source 22 and typically placed very near subject 20, can be positioned between the patient's right and left knees and is thus capable of positioning over the full circular orbit. A computer or other type of logic processor 30 is in signal communication with radiation source 22 and detector 24 for control of system operation and for obtaining images at a number of angular positions and accessing and processing the data. A display 32 is in signal communication with processor 30 for displaying results, as well as for storing the acquired and processed volume image content in a memory 26 and for transmitting the image data to one or more other processors, such as through a network connection, not shown.

A full 360 degree orbit of the source and detector may not be needed for conventional CBCT imaging; instead, sufficient information for image reconstruction can often be obtained with an orbital scan range that just exceeds 180 degrees by the angle of the cone beam itself, for example.

Using a volume imaging apparatus such as that shown schematically in FIG. 1A, volume image data content is obtained that represents the 3D image data as a collection of image voxels that can then be manipulated and used to display volume images represented as 2-dimensional views or slices of the data.

Embodiments of the present disclosure describe a number of measurements and calculations that can be used to characterize the condition of a bone joint for a patient. Characterization techniques described herein can provide metrics for various aspects of joint health, including measurements and calculations and distributions of data that can be visualized on a display or printed surface.

Bone joint distance is proportional to the overall pressure that is applied to the bone and therefore provides a useful first approximation for overall joint condition. FIG. 1B shows, in schematic form, a measurement apparatus used for correlating bone distance to pressure and determining the contact area for bone surfaces, using a measurement system from Tekscan, Inc., Boston, Mass. with a simulated bone joint. Weight W is used to apply a fixed or variable force to a joint J1 in the load-bearing direction, as indicated by a dashed arrow, allowing measurement of pressure under a range of weight conditions. A transducer 110 is used to provide a matrix of signals indicative of distance and/or pressure at different points along the bone surface. In vitro measurements can also be obtained using appropriate instrumentation.

Based on the sensed pressure measurements from transducer 110 and on the weight W applied, the relationship between weight and pressure over the surface area that corresponds to the transducer can be modeled. Results of the pressure measurements can be used, for example, to generate a look-up table (LUT) that gives the corresponding pressure related to weight. In addition, by scanning the joint J1 with a volume imaging apparatus such as that shown schematically in FIG. 1A, a pressure-to-distance mapping may be obtained, using an LUT for discrete values or by generating a graph that allows interpolated values to be used as well, as shown in more detail subsequently.

FIG. 1C shows a knee joint used for pressure measurement with the test arrangement of FIG. 1B, as displayed from volume image content. FIG. 1D shows, by way of example, a visualization of the measured pressure data that can be obtained from the transducer 110 of the Tekscan system. Different grayscale or color values display according to pressure detected at different positions along the transducer 110 array.

Embodiments of the present disclosure provide methods for obtaining, from the volume image content, measurement data that characterizes the bone joint and provides useful information on joint spacing and contact area characteristics.

Information that can be particularly useful for diagnosis of RA and other joint conditions relates to spacing between skeletal surface structures and characterization of contact surface areas where bone and related articular cartilage come into close proximity in order to cooperate for allowing articulated movement at the joint. Of particular interest for methods of the present disclosure is the relationship of distance between skeletal surfaces and corresponding pressure of synovial fluid and upon cartilage within the joint. While the relationship of distance to pressure can be complex and can be affected by various factors depending on the particular joints being examined, it is apparent that the overall relationship of distance as inversely proportional to pressure is diagnostically useful as a first-approximation indicator of RA and other joint conditions.

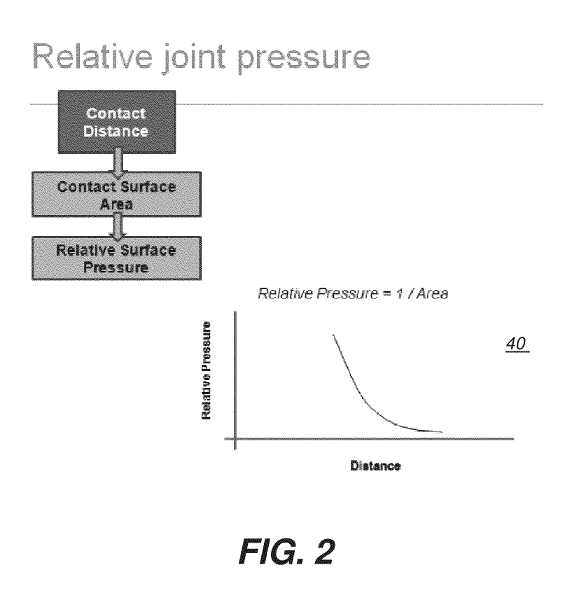

FIG. 2 shows a graph 40 that relates joint distance to pressure as a first-order approximation. A contact distance over a given contact surface area provides a measurement that characterizes relative surface pressure over an area in an inverse relationship. At very close distances, pressure that is applied to the fluid region between skeletal structures can be correspondingly very high. As distance increases, pressure on contact surfaces of the bone joint drops substantially.

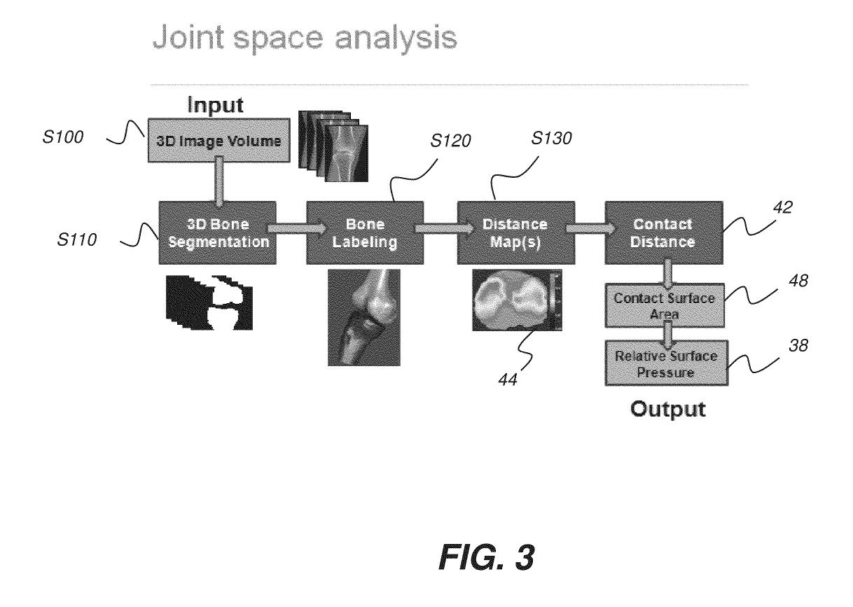

FIG. 3 generally illustrates a processing sequence for generating a joint space analysis mapping. A 3D image volume of at least the bone joint area is acquired in a volume image content acquisition step S100. Acquisition of the 3-D volume image can be accomplished by CT (computed tomography), CBCT (cone beam computed tomography), and/or MRI (magnetic resonance imaging). A 3D bone segmentation step S110 can then be executed, identifying and isolating bone content under analysis from background tissue and other background image content outside the bone structure. The bone content can be automatically selected or can be selected interactively by the user. Alternately, the user can be allowed to interactively select at least two bones from a plurality of bone structures for subsequent automatic computation. The bone surface, that includes any associated cartilage, can be segmented from other features. A bone labeling step S120 then identifies individual bones for subsequent analysis. Segmentation and labeling are processes executed by a logic processor 30 (FIG. 1) on the acquired 3D image content. Labeling can use pattern recognition techniques familiar to those skilled in the image processing and analysis arts for automatically labeling individual joints. Labeling methods can also automatically connect identified bone joint components for labeling a joint. Segmentation can use relative bone density in order to define areas of cortical bone, for example. Bone density can be characterized using Hounsfield units, for example.

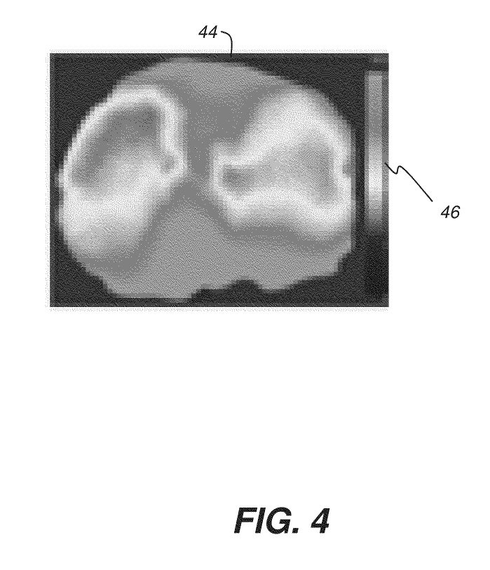

Once segmentation and labeling steps have been completed, a distance map generation step S130 can be executed. FIG. 4 shows an example of a distance map 44 for a portion of a bone joint. The map 44 in this example is shown apart from any surface image and is color-coded to show the relative joint distance over each corresponding section of the map. The color map can alternately be superimposed on the display of a joint surface and can be particularly useful for analyzing pressure for a weight-bearing joint. A key 46 provides a guide to distances corresponding to each color. The distance map can be automatically selected and generated by the system, using default parameters and settings. Alternately, the viewer can specify a portion of the displayed joint over which a distance map is desired, such as by outlining or otherwise selecting a portion of a displayed joint, for example. Features such as pan and zoom in/out allow visibility of the distance map over desired portions of the surface.

Referring back to the sequence shown in FIG. 3, additional output provided by joint space analysis includes other methods of reporting a contact distance 42 for any particular point within the joint. A contact surface area 48 can be generated, such as by segmenting surfaces within the joint according to information on contact or relative proximity. Relative surface pressure 38 data can be calculated and provided in any of a number of ways, such as using a mapping display similar to the distance map or by providing averaged data or information on any particularly high pressure points detected within the joint according to joint pressure. Other joint space parameters that can be calculated include distance, minimum and maximum distance, mode (distribution), distribution of weight or pressure, skew or overall shape of a histogram, standard deviation, and contact surface area, for example. One or more joint spacing parameters can be displayed in a time series, including a time series showing effects of drug therapy.

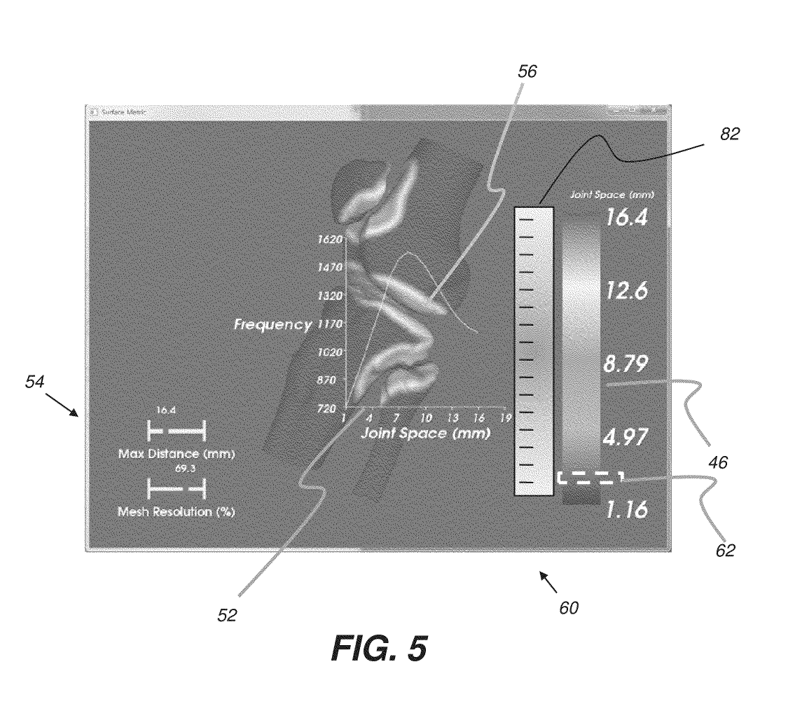

By way of example, FIG. 5 shows a display of joint spacing analysis results. A 3-D surface of bone joint features is color-coded to represent relative distance between surface features at the joint. Bone surface 56 shows the edges of bone within the joint 60 both bone and surface cartilage, as noted previously. Key 46 shows the distance encoding. A graph 52 shows a histogram for number of voxels on facing surfaces having a given spacing distance. Another graph 82 relates the measured distance to pressure, based on an LUT or graph, as described previously. Controls 54 allow the viewer to adjust the displayed distance color as well as the mesh resolution used for the surface reconstruction. Additional viewer utilities allow the practitioner to view calculated pressure using similar tools. An optional sliding bar 62 associated with key 46 allows the practitioner to selectively display or highlight bone spacing or pressure above or below a particular threshold.

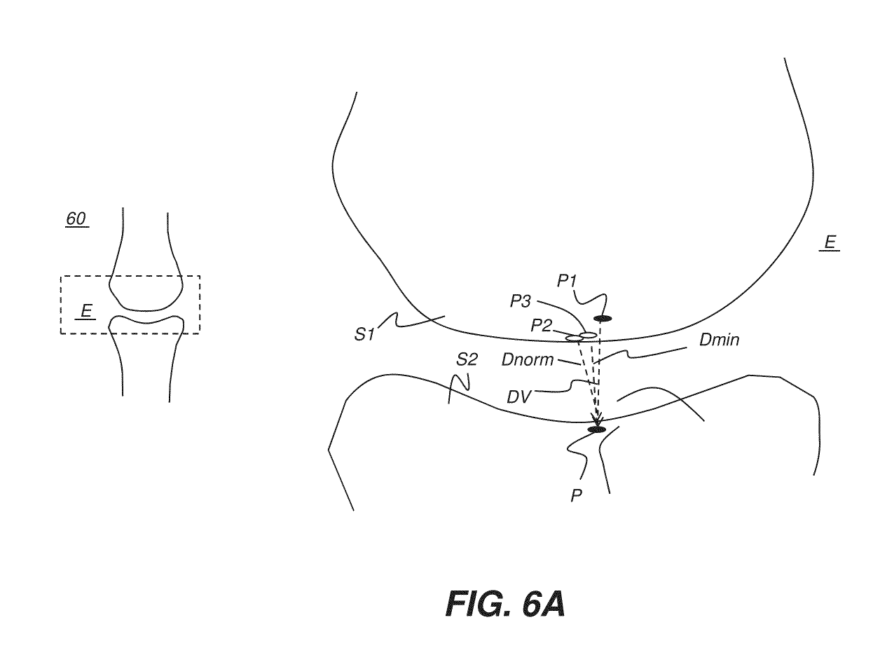

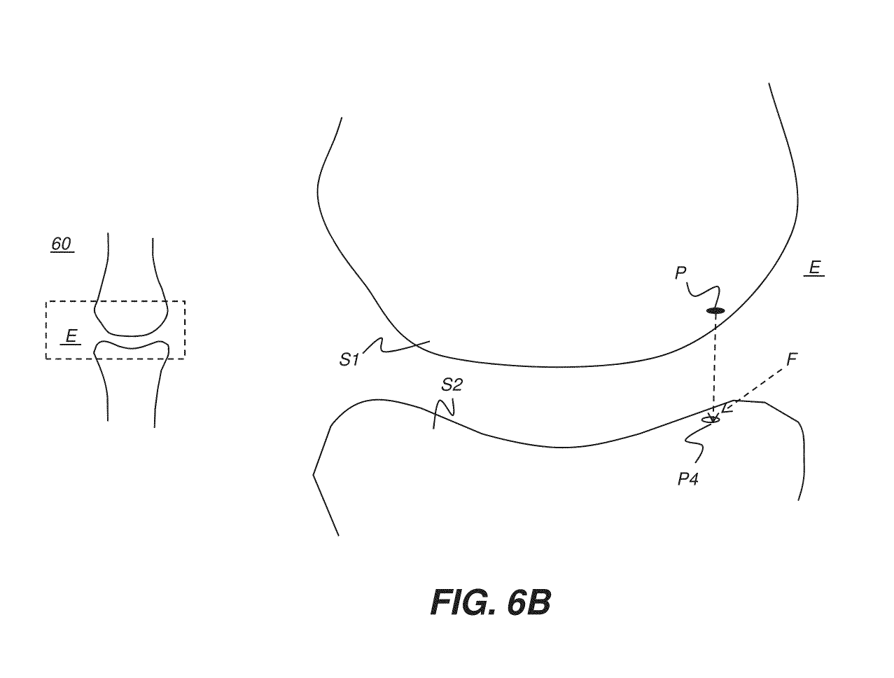

Distance values for a single point in the bone joint can be computed for a number of slightly different distance metrics, as shown in FIG. 6A for the enlarged view E of bone joint 60. Pressure and distance measurement has most diagnostic value when considered for upper portions and bone surfaces of a lower weight-bearing limb. A point P on a surface S2 can have multiple possible distance vectors that extend towards corresponding facing points on a facing surface S1 of joint 60; one of the distance vectors is selected by the software that executes distance calculation and display. Extending a vertical vector from point P to a point P1 on surface Si gives a vertical distance DV that can be indicative of weight. Extending a normal from point P extends toward a different point P2 on surface S1 at a distance DNorm. Detecting the shortest distance from point P to a point P3 on surface S1 obtains a distance DMin. Force contribution from each of points P1, P2, and P3 can be slightly different, based on factors of proximity, weight, surface shape, and movement directions, for example.

The relative diagnostic significance of the different distance metrics shown for a joint in FIG. 6A can depend on the function of the bone joint. For a load-bearing joint, such as a knee or hip, for example, the vertical distance DV may be of most significance as providing a proportional measure of pressure at various surface points at the joint. Lower bone surfaces are generally of most interest for spacing and pressure analysis. For other joints, the nearest distance DMin may be of most diagnostic interest, such as where friction or sliding interaction between surfaces is typical. Alternately, the normal distance DNorm may have be of most diagnostic interest.

FIG. 6B is a schematic diagram that shows an additional sliding force F that can further complicate the pressure analysis at a point P4. A vector addition analysis can be used to characterize pressure factors at a particular point along a lower surface S2, such as sliding force F in any direction.

In some cases, bone joint analysis can include additional processing to re-align bone position for one or more bone structures within the joint, according to pressure exerted by the patient's weight. In the case of an injury or fracture, simulated behavior along a weight-bearing joint may be used as a model, such as where it would not be feasible to obtain an image of the limb under actual weight-bearing conditions. Volume images of the joint features can be used to simulate joint behavior according to the model and can be used to guide treatment of the injury.

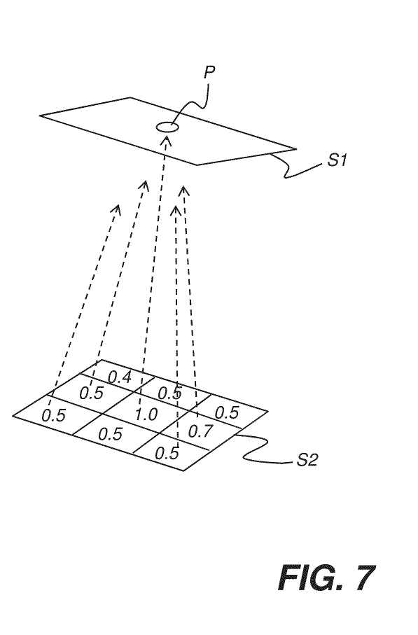

In addition to point-by-point proximity along joint surfaces, the pressure contribution from nearby points may be of diagnostic interest. The schematic diagram of FIG. 7 shows a weighting scheme that applies different weights or strengths to the overall pressure contribution onto surface S1 from a set of nearby points on facing surface S2.

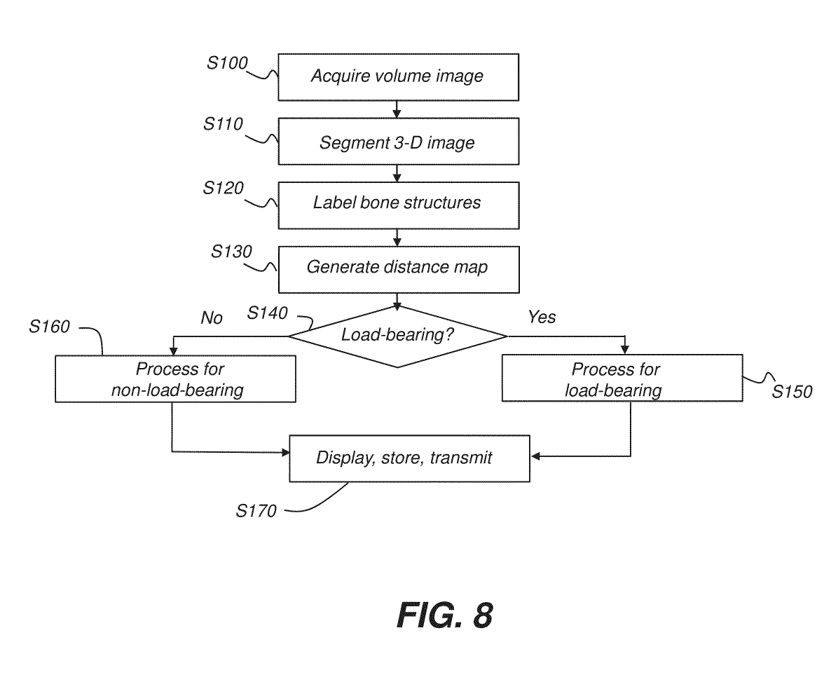

FIG. 8 is a logic flow diagram that shows a sequence for characterizing a bone joint of a patient. Volume image content acquisition step S100 accesses 3-D volume image content generated by a system such as a CBCT or other tomographic imaging apparatus. The 3-D volume image content may be from stored data, for example. 3D bone segmentation step S110 then segments a 3-D bone region from the 3-D volume image to generate a 3-D bone volume image having voxels and at least one joint, wherein at least a first bone surface is in proximity to a second bone surface. Segmentation processes for identifying and isolating various bone structures are well known to those skilled in the diagnostic imaging analysis arts and include various types of thresholding techniques, for example. Density thresholds can be used, for example, to identify cortical bone that forms the surface structure that is of interest for joint analysis. A bone labeling step S120 then identifies individual bones for subsequent analysis. Shape recognition and various types of a priori information can be used to assist the segmentation and bone labeling processes.

Distance map generation step S130 then computes distances between points on facing surfaces S1 and S2 using a predetermined distance metric, as described previously. A decision step S140 then determines whether or not the joint is imaged under load-bearing conditions. For a load-bearing joint, a processing step S150 applies higher weighting to vertical distance, with some considering for weighting of other nearby distance values, as well as considering the contribution of sliding forces as shown in FIG. 6B. For a non-load-bearing joint, a processing step S160 applies a different set of characterization criteria, giving higher weighting to minimum distance, for example, or to normal distance for various joint types. Contributions of nearby points on facing surfaces can have different weightings based on the joint type and distance and proximity point weightings as well as forces from sliding motion, as described previously. For either process S150 or S160, the analyzed joint space parameters can include: distance, minimum and maximum distance, mode (distribution), skew or shape of histogram, standard deviation, contact surface area, and relative surface pressure.

A display step S170 then assigns color or other appearance characteristics to voxel values, conditioned by the computed distances. Deep red colors, for example, can be assigned to contact areas or areas within a minimum distance of a facing surface. Display step S170 can display the reconstructed volume, display only the contact surface features, or display only distance mapping information, depending on system design and, optionally, operator preference. The generated data can alternately be stored or transmitted to a different computer or processor.

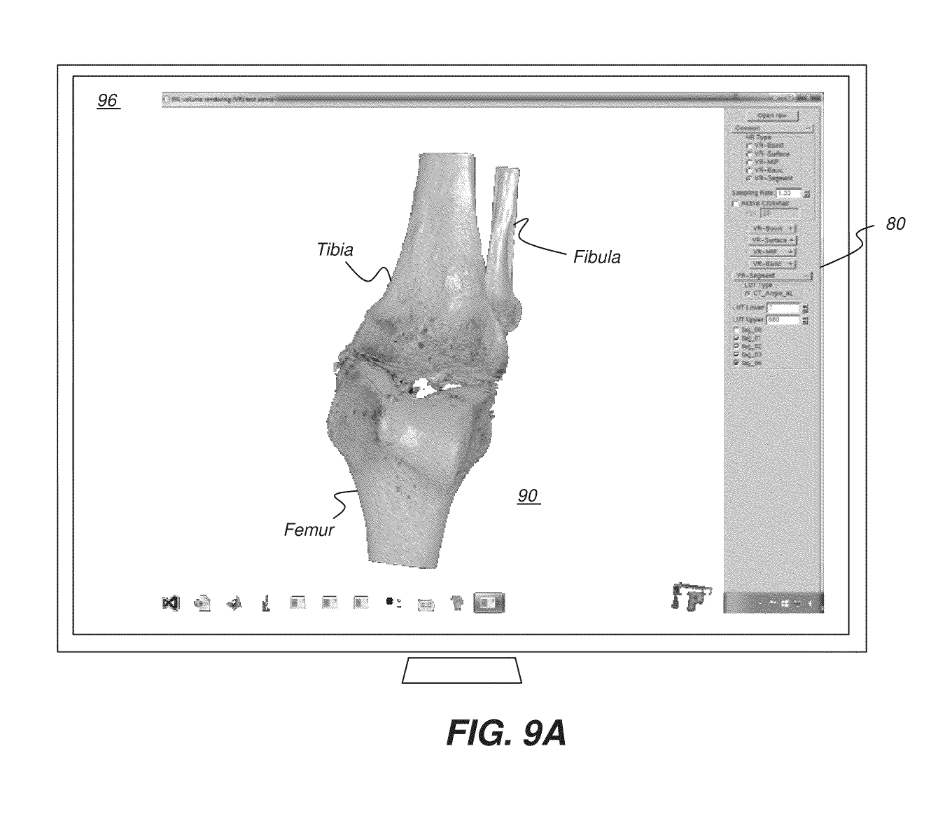

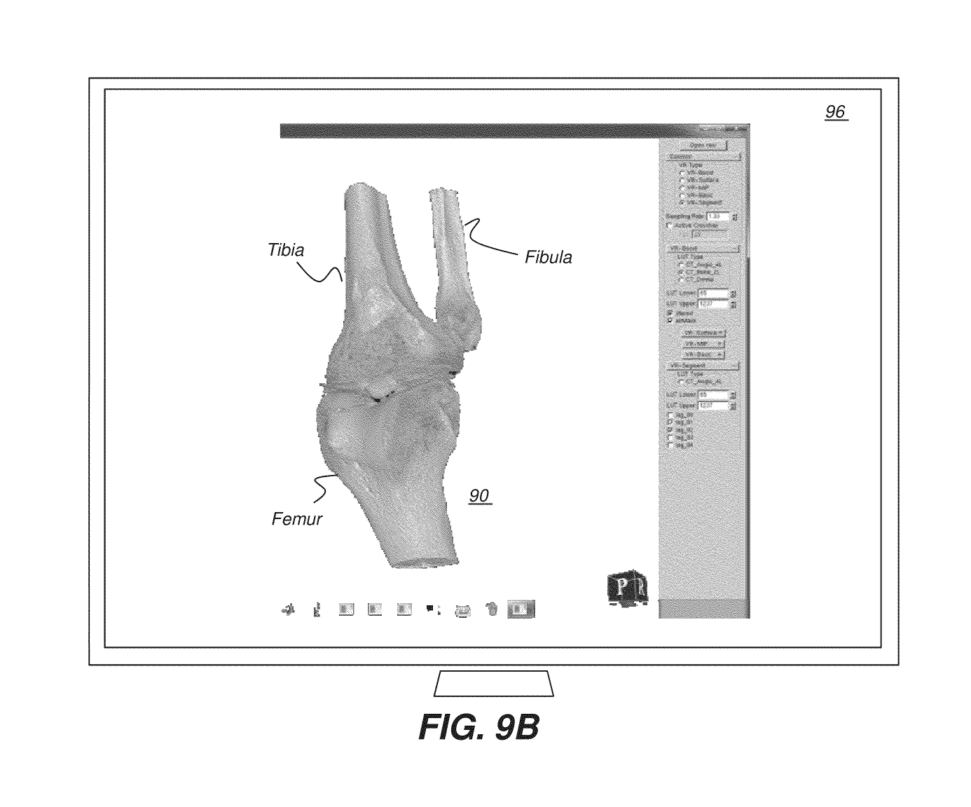

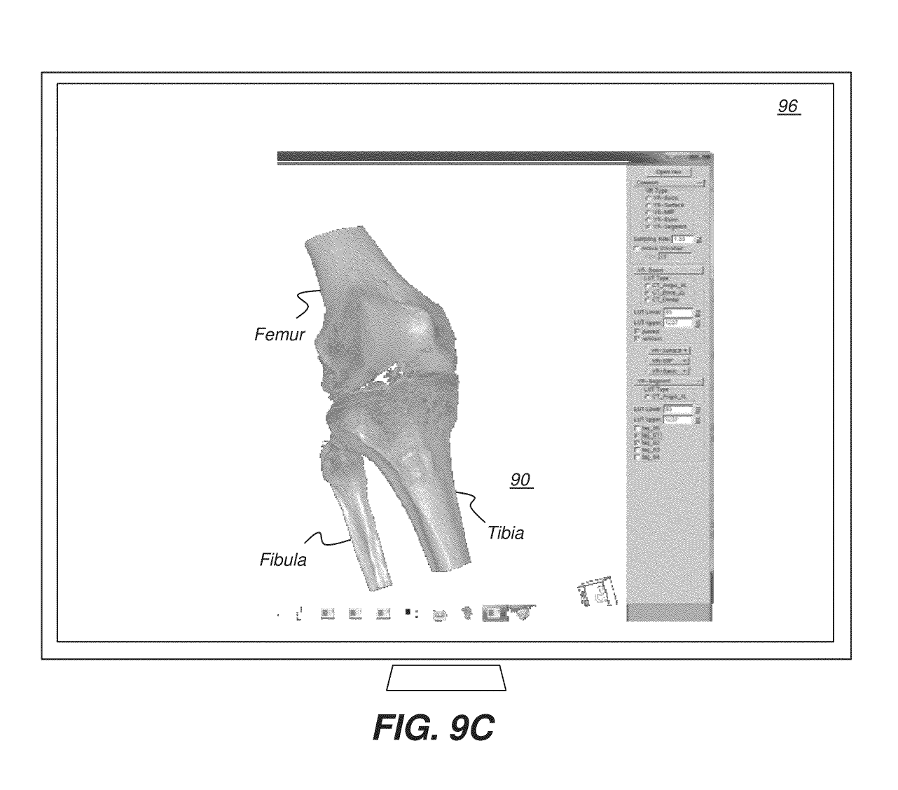

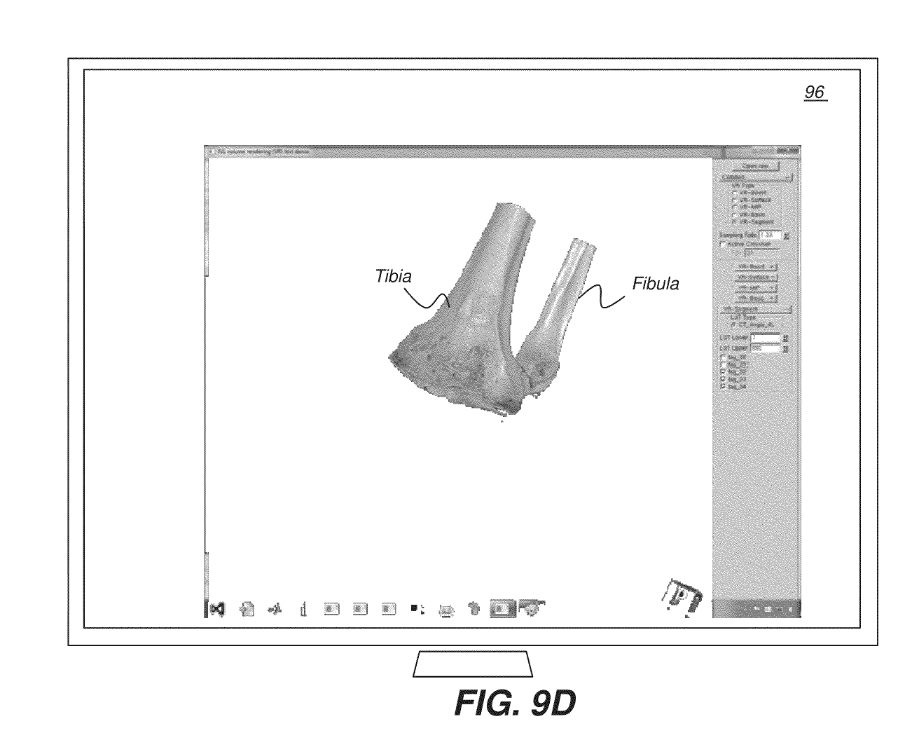

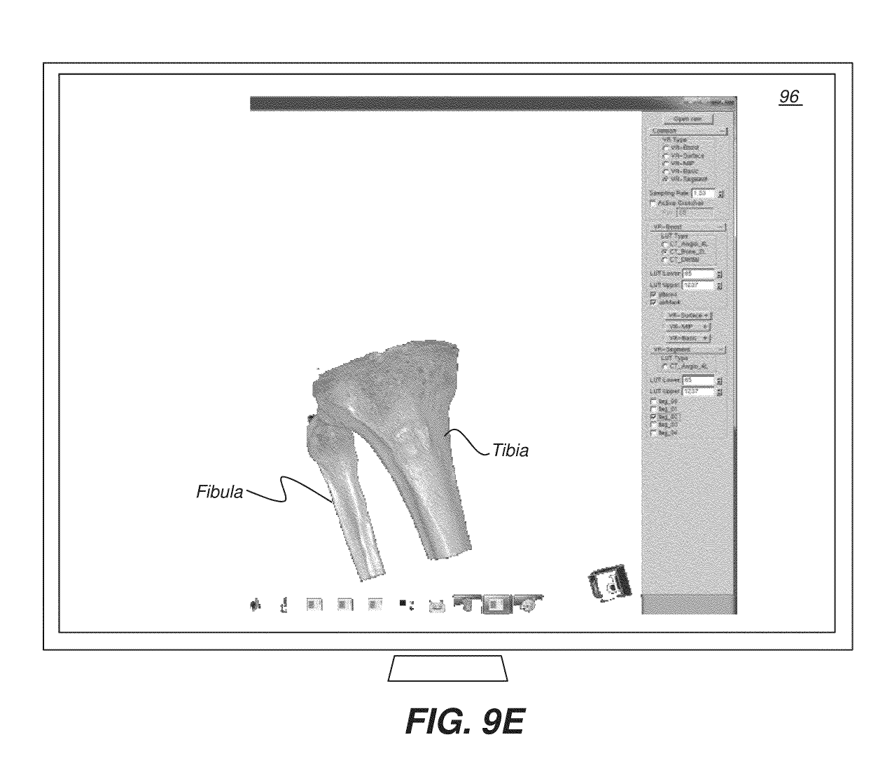

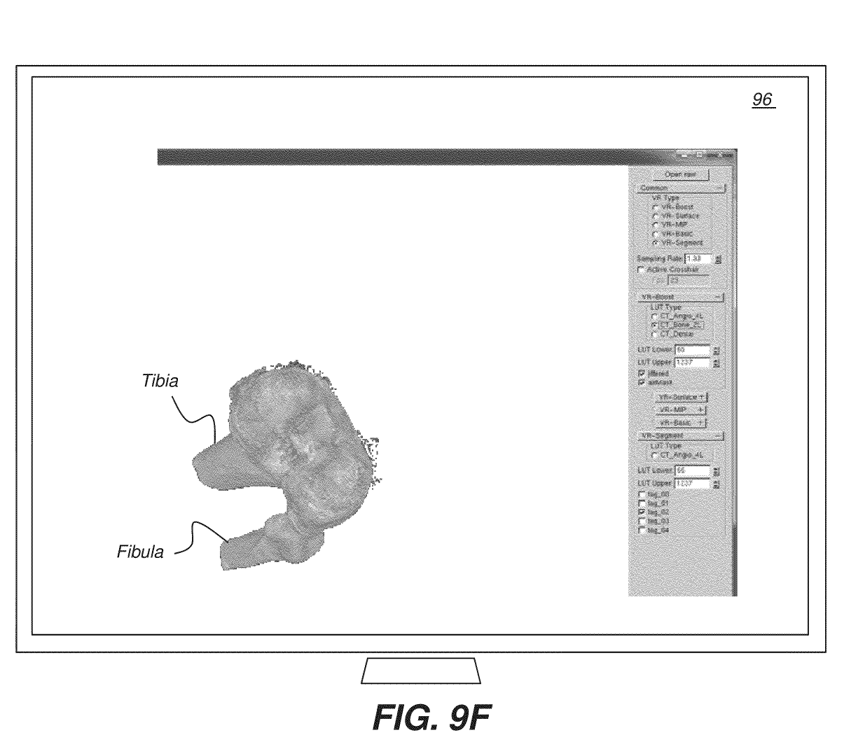

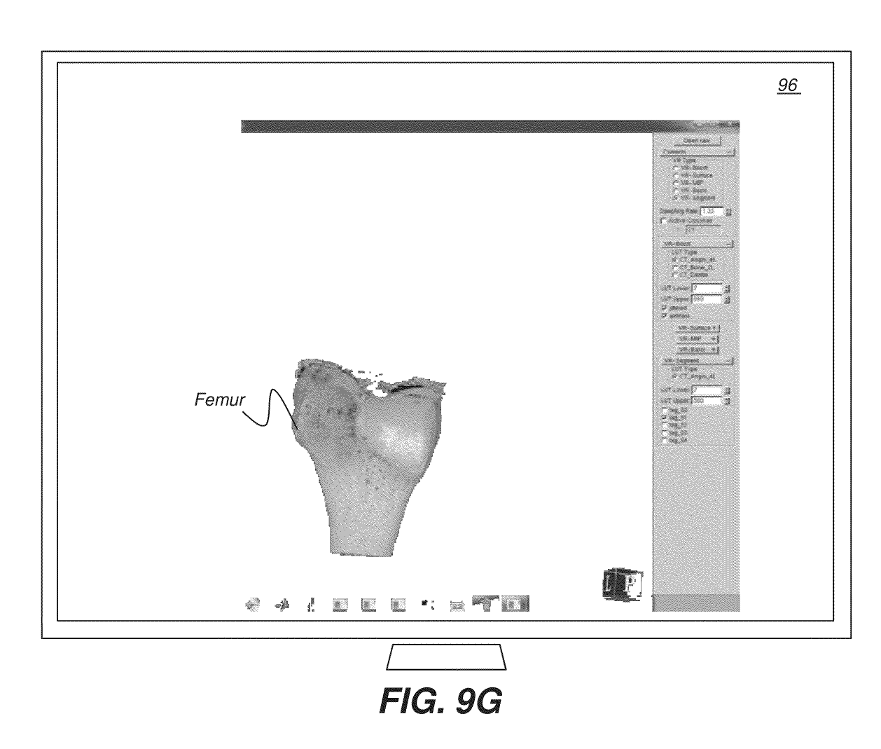

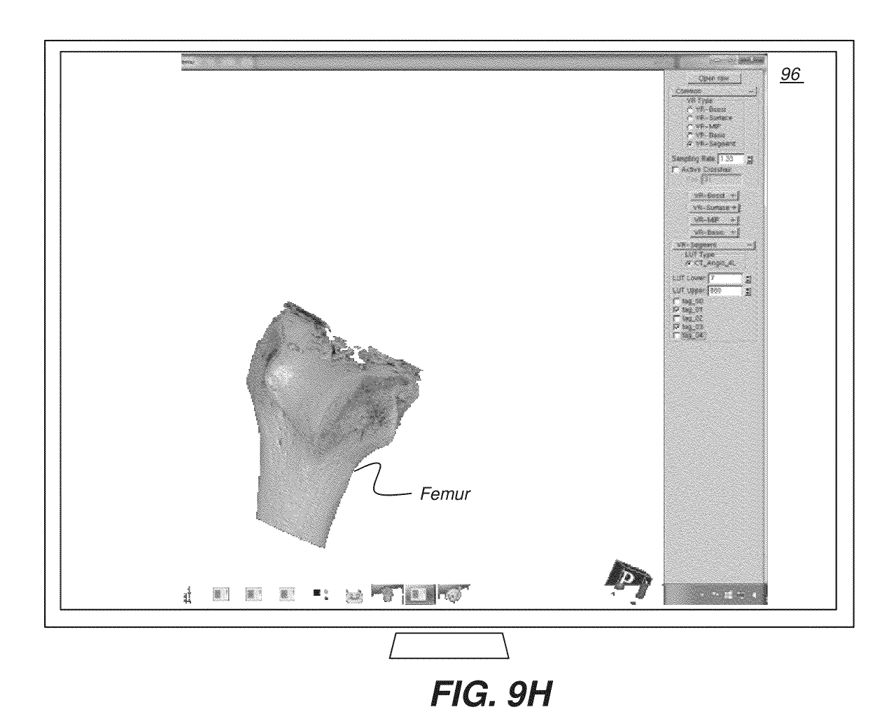

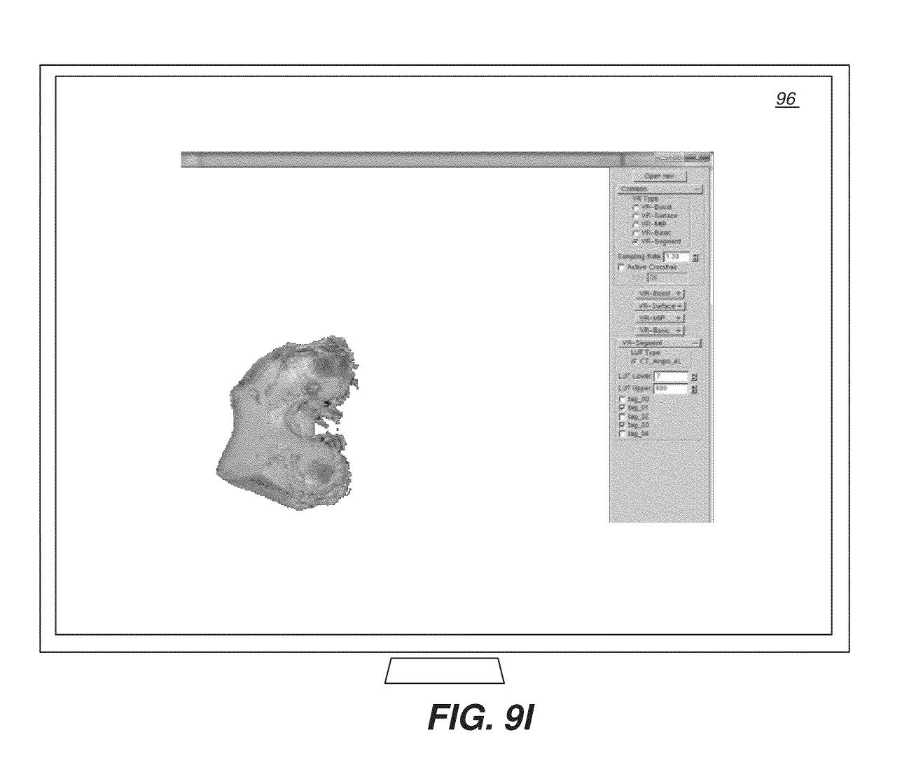

FIGS. 9A through 9I show additional features of an operator interface for segmentation, labeling, and generating various distance and pressure data from volume images of a bone joint, using a knee joint 90 as an example. A control panel 80 shows a number of exemplary controls for providing various views of the segmented bone structure as part of the operator interface. A multi-window display can be used to simultaneously show bone joint condition and spacing from various angles, allowing the practitioner to rotate one or more different views, for example.

FIGS. 9A, 9B, and 9C show 3-D a display 96 having views of the tibia, fibula, and femur bones at the joint 90 at various angles. The operator interface allows display of the imaged bone joint at viewer-specified angles and orientations, enabling a practitioner to view and assess the joint from different aspects.

In a similar manner, FIGS. 9D, 9E, and 9F show display 96 with various rotational and oriented views of the segmented tibia and fibula.

Segmentation utilities allow the practitioner to view bones and surfaces of particular features, isolated from other structures of the joint. FIGS. 9G, 9H, and 9I show different views of the segmented femur. The operator interface provides the controls needed to specify one or more of the labeled bones for display and to select and change its orientation as needed.

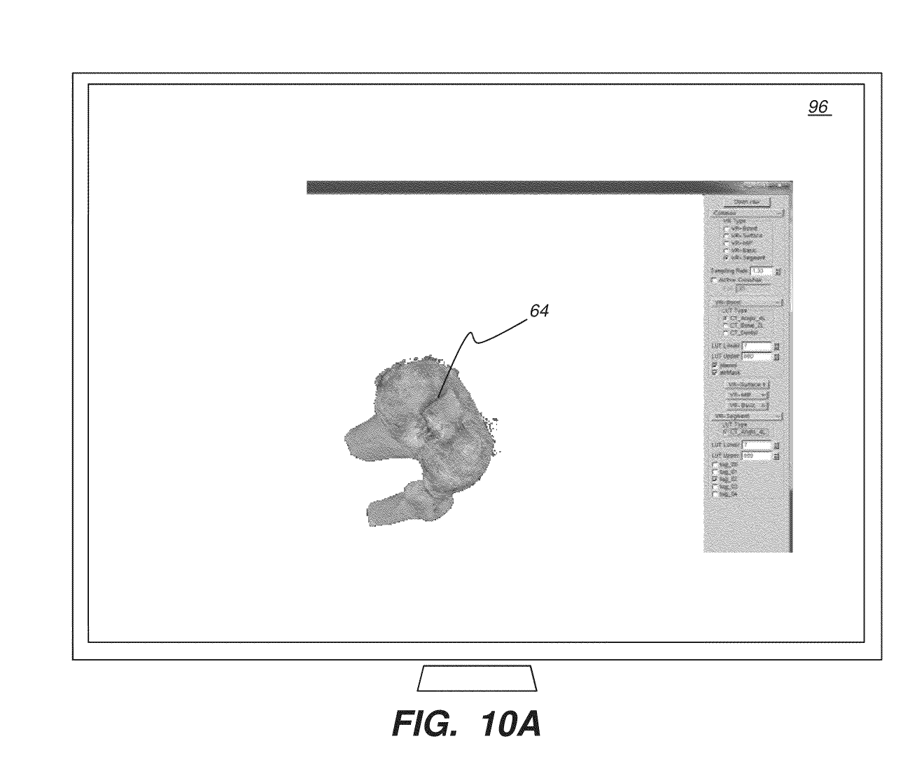

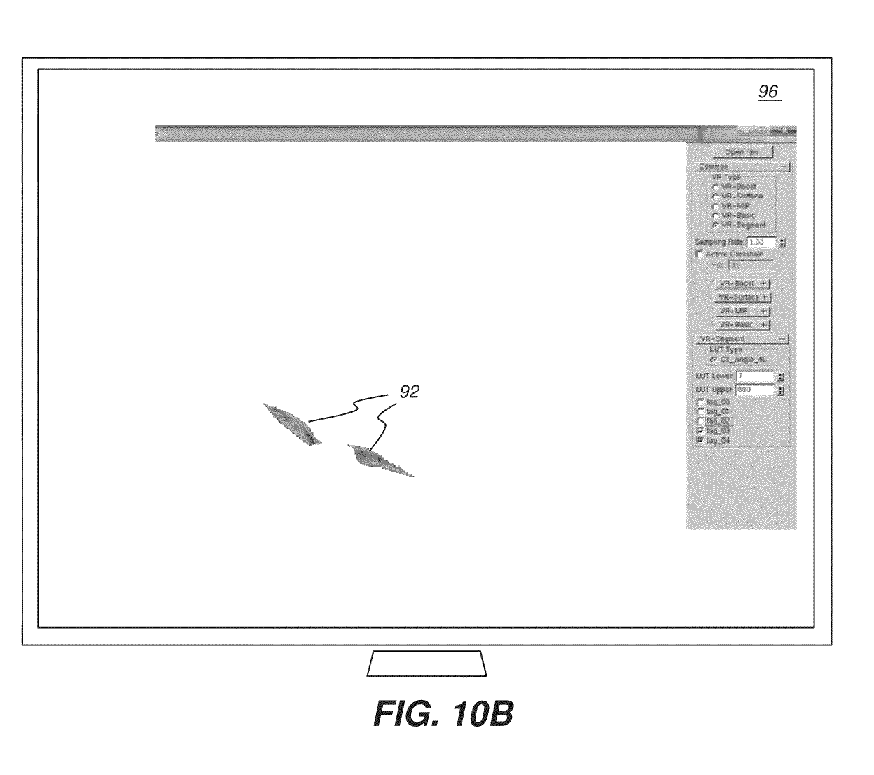

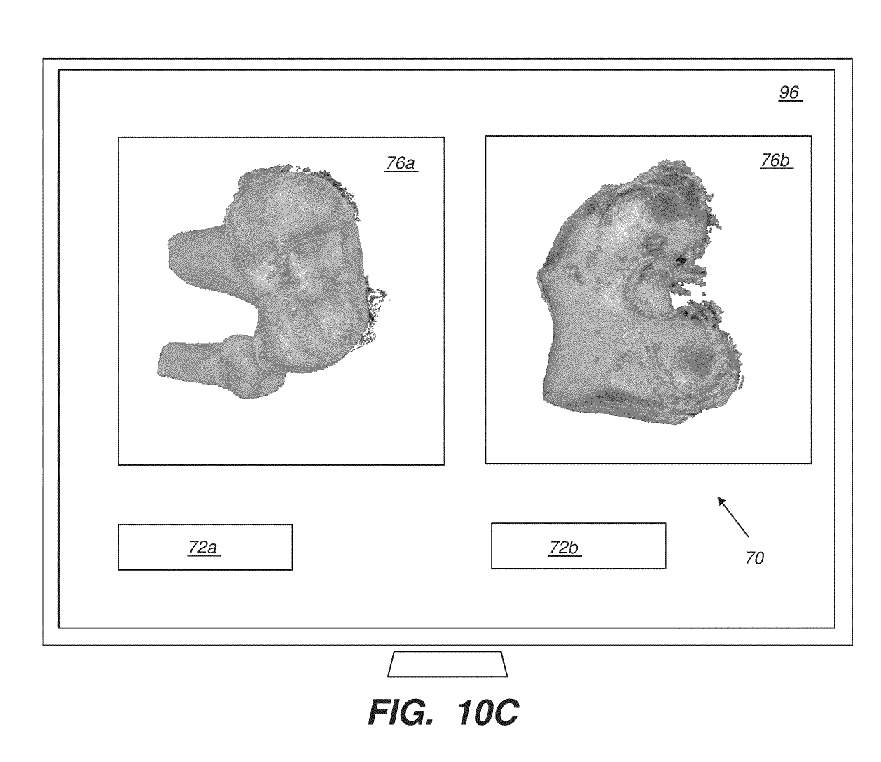

FIG. 10A shows highlighting 64 that corresponds to a pressure mapping superimposed on joint structures.

According to an embodiment of the present disclosure, an image of the volume between facing bone surfaces can be generated. FIG. 10B shows segmentation and display of a space 92, the gap volume between bones. With this type of display, the spacing between bones itself can be viewed and highlighted independently from the corresponding bone surfaces. Space 92 in FIG. 10B represents the gap volume that is bounded by the facing bone surfaces, with its perimeter defined within a predetermined distance threshold. Thus, for example, space 92 can be a volume image of all distance between bones of less than a given value. The gap volume can itself be segmented and can be shown and measured by particular regions of interest and in medial, lateral, or other views, similar to the volume images of segmented bone structures. This segmentation of space, providing a 3-D view of the fluid space that lies within the joint, can be a useful guide to assessing an arthritic or other debilitating condition that compromises patient mobility. Changes in the volume spacing between joint surfaces over time can be a more robust quantitative measure of cartilage loss, providing numeric values for global deterioration of a joint, provided by changes in the overall computed volume between the surfaces, or for local analysis of a particular region of the joint, such as where a fracture, bone spur, or other condition contributes to loss of cartilage.

According to an embodiment of the present disclosure, the volume of space 92 within a joint is calculated for comparison with the calculated volume from a previous imaging exam in order to characterize bone joint condition according to its rate of change. Optionally, histogram data related to the joint spacing is used to provide a metric based on changes in distance distribution over a time period. Color-encoded display of the bone volume can help to further characterize the condition of a particular joint with localized information. Using the detected volume within the bone joint can prove to be a fairly robust method for characterization of the joint and of relative cartilage loss over time and information on the total volume, distribution of the volume, and change in volume over time offers more information about the joint when compared against use of distance measures by themselves.

Another feature of an embodiment of the present disclosure relates to the capability to simulate selective, partial disassembly of the joint structure, allowing each bone feature of the joint to be displayed individually or in combination with only a subset of the other bones in the joint. Referring to FIG. 10C, there is shown a display 96 that shows an unfolded view 70 of opposing or facing joint surfaces 76a and 76b. According to an embodiment of the present disclosure, unfolded view 70 is automatically generated by the system software upon selection by the viewer. The unfolded view allows showing the segmented first and second facing bone surfaces separately, from the perspective as each surface faces the other within the joint. The primary facing surfaces of the bone joint are visualized as separate from each other, enabling the simultaneous display of the inner surface at the joint interface that is not otherwise visible from any perspective view of the complete, functioning joint. Controls 72a and 72b enable manipulation of each of the surface images, respectively, in unison or independently with respect to each other.

Another feature of methods and utilities provided by the present disclosure allows a practitioner to compare volume images obtained from the patient over a period of time. Images acquired one or two years previously, for example, can help the practitioner to view and quantify changes to bone spacing and corresponding pressure by allowing the use of volume images of the bone spacing itself. The use of a sliding bar or other visual tool can further enhance the view of bone spacing as shown in FIGS. 10B and 10C, allowing the practitioner to more closely view spacing parameters.

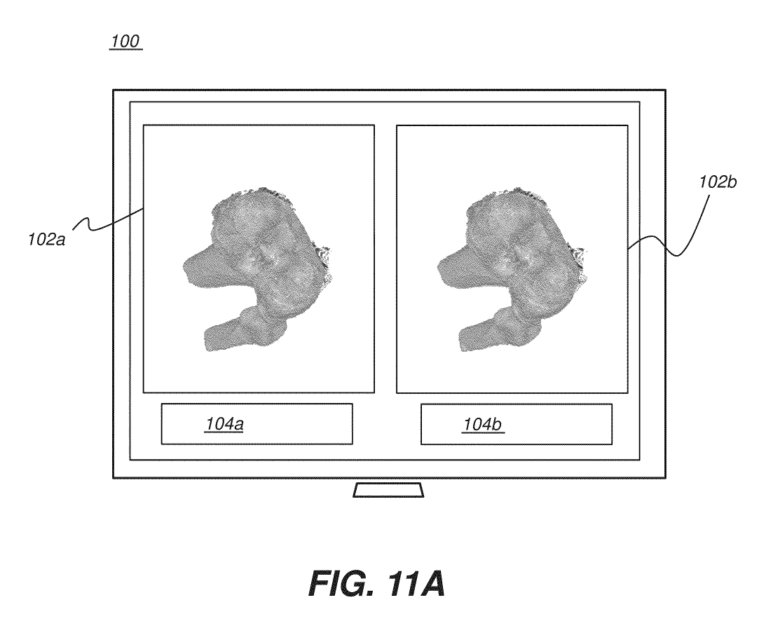

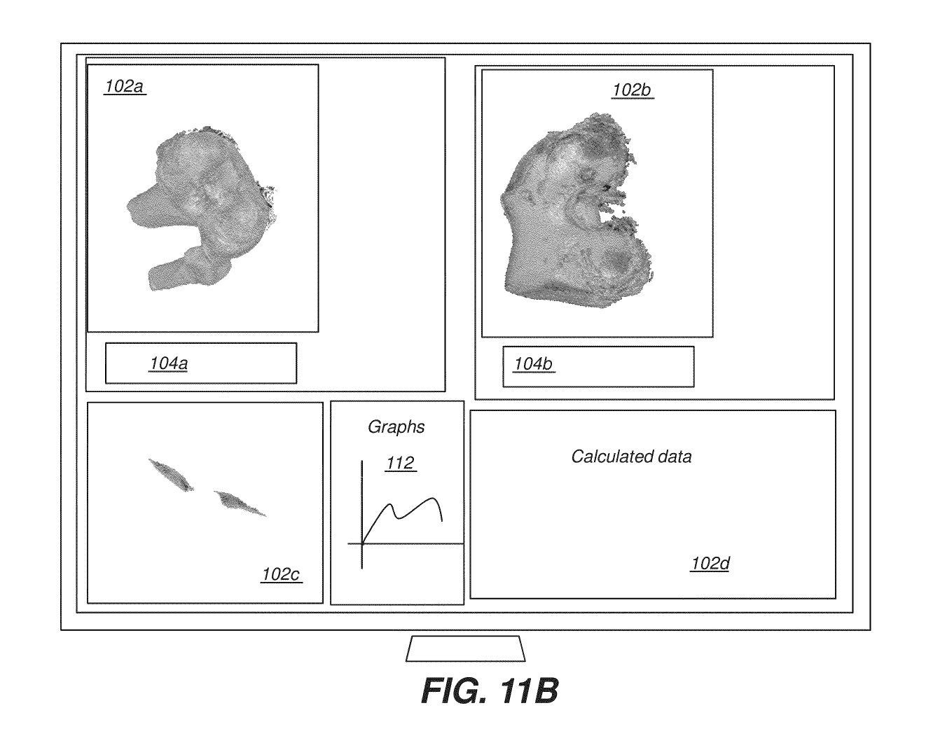

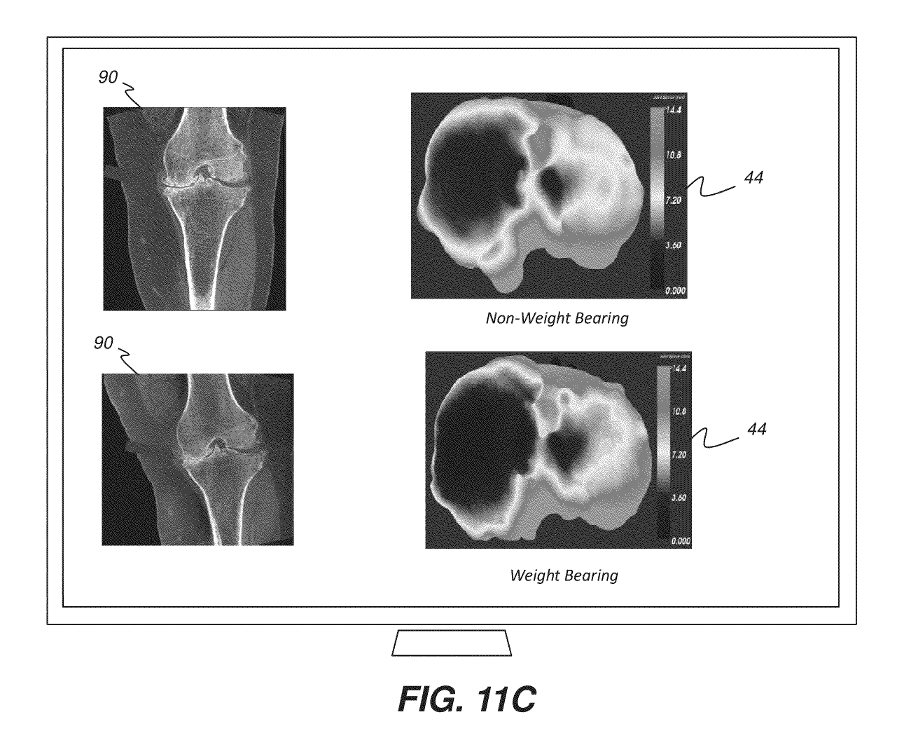

FIG. 11A shows an example display screen 100 with side-by side windows 102a, 102b for comparing earlier and more current volume images of joints and joint surfaces. Each window 102a, 102b has a corresponding control panel 104a, 104b for adjusting visibility, scale, color, distance/pressure thresholds, and other attributes of the displayed image content. Automated registration to a template for joint and bone type and orientation, with optional segmentation automatically executed depending on the template parameters, allows the viewer the benefit of both qualitative and quantitative assessment of bone joint features for earlier and current images, so that the change over time can be measured. Automated registration to the template provides a fixed starting point for image comparison. Once registered and displayed, the images are then available for view manipulation and scaling, either independent of each other or according to the same adjustment parameters. Thus, for example, the practitioner can begin with a standard template view for each image and simultaneously rotate the viewed content in order to compare views of the same tissue taken at different time periods. Alternately, the windowed view of FIG. 11A can be used to compare the patient with a previously generated standard, such as a model image obtained from a sampling of a similar population as that of the particular patient being examined. The side-by-side view of FIGS. 11A-11C can also be useful for display of the patient's joint in a time series in conjunction with drug therapy or other treatment.

FIG. 11B is a schematic diagram that shows a multi-window display for viewing multiple images and associated data related to bone joint characterization. Windows 102a and 102b can show an unfolded view, or facing-surfaces view, of the joint as described with reference to FIG. 10C, a time-lapse view of the same joint or joint surface from different exams, as shown in FIG. 11A, or any number of other images, along with associated control panels 104a, 104b. Another window 102c can show the volume of joint spacing for the images shown. Data in one or more graphs 112 can show histogram information for one or more images, including a histogram showing the distribution of spacing distances, for example. An optional window 102d can show calculated data, such as percentage cartilage loss for the joint, either over a specific region or over the full region of the joint. Images and calculations for a particular patient can be shown relative to a joint spacing parameter of an average/baseline patient.

According to an alternate embodiment of the present disclosure, the control logic for the volume image processing monitors spacing volume changes and automatically detects and reports change values that exceed predetermined threshold values. Reporting can use various metrics that have potential diagnostic value, such as number of pixels or voxels having changed values or the overall volume calculation that vary between exams, for example.

Visual and quantitative comparison of image content and measured values for smoothness and texture of bone surfaces at the joint can also display as calculated or visual data in the display of FIG. 11B. A roughness parameter Ra can be calculated using well-established techniques for smoothness characterization, such as an arithmetic average, a root-mean-squared (RMS) value, or other metric. Other calculated values can list the contact area of a joint, such as by considering all facing surfaces at a distance that is less than a given threshold as a contact area (for example, facing surfaces less than 1 mm apart). Contact area can be expressed as a percentage of the bone surface or as a value for each bone, computed using distance or pressure data. Bone data can be displayed in a time series. Changes in the contact area or gap volume, from one exam to the next, can indicate the progress of a particular condition.

It can also be advantageous to show the bone joint characterization under both weight-bearing and non-weight bearing conditions. FIG. 11C shows an example display that can be used for this comparison. For each condition, the display can show an image of joint 90 and distance map 44 or other pressure/distance mapping. Alternately, the gap volume can be segmented and displayed for weight-bearing and non-weight bearing conditions.

Additional data can also be provided by the imaging apparatus as indicators of overall bone density. Given the joint and segmented and labeled bone structures, the relative Hounsfield values of voxels can be an indicator of trabecular bone mass and overall bone strength near the joint. Trabecular structure can be segmented and calculated for relative volume near the joint, for example, by showing a percentage of trabecular bone structure to other bone material.

Templates can be devised not only to specify fixed perspective views, but also to compare joint spacing and pressure for an individual patient with standard measurements from a population of patients, allowing a grading or scoring to be used as a metric for bone joint health assessment.

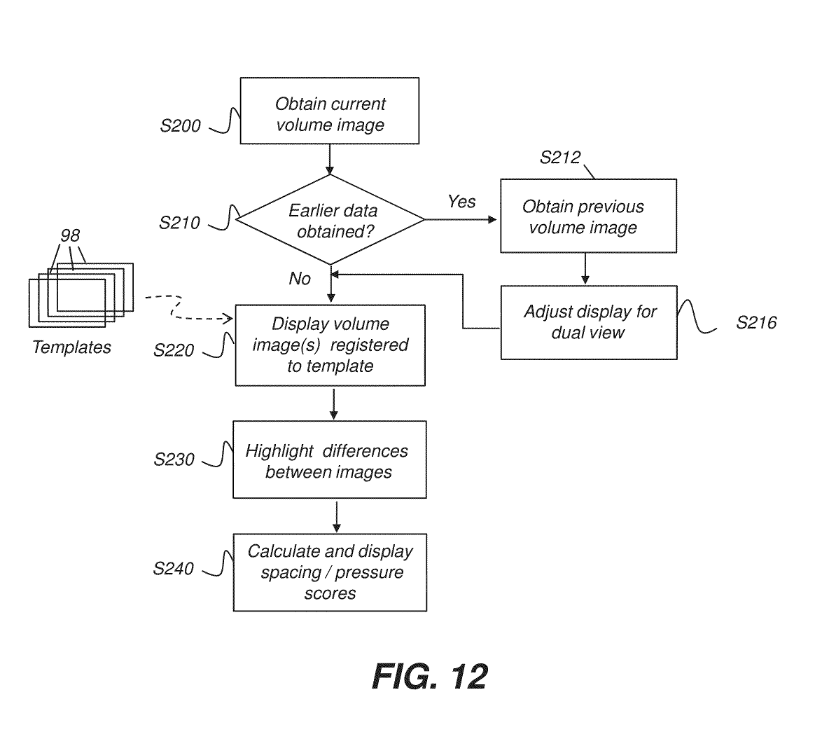

The logic flow diagram of FIG. 12 shows a sequence for display of joint features using templates, including multi-window display and manipulation as described with reference to FIGS. 11A and 11B. In a volume image content acquisition step S200, the reconstructed volume image for the bone joint is acquired. A test step S210 checks patient records to determine whether or not there is previous bone joint volume image data available for the patient, such as obtained in an examination two years ago, for example. Where earlier volume data is available, processing executes the optional acquisition step S212 of obtaining the previous image data and a configuration step S216 of display configuration that sets up display screen parameters for side-by-side display as shown in FIG. 11A or other multi-window display setup. A registration and display step S220 then obtains a template 98 that is suitable for the particular joint of interest. By way of example, and not by limitation, template 98 can have the following content:

(i) identification of bone joint components for display;

(ii) initial angle for bone joint orientation;

(iii) initial scale specifications;

(iv) color mapping for different distance measurements; and

(v) segmentation specifications.

Various other content can also be contained in template 98.

Continuing with the sequence of FIG. 12, a registration and display step S220 follows the requirements of the specified template 98 for both the previous and current volume image. In a highlighting step S230, an automated analysis is executed and differences between images that have been detected are highlighted in the display, such as using color or other display treatment. A scoring step S240 calculates and displays information that relates to a predetermined standard scoring for interjoint spacing or pressure measurement. Scoring for joint distance can be on a numerical scale, such as a 1-100 scale that uses sampled calculations or simply evaluates joint condition based on averaged spacing or changes to spacing.

Bone density and related trabecular structure of the inner portions of the bone near the joint surface can also be a useful indicator of overall bone health and joint condition. Bone surface smoothness, providing a close view of bone texture that is available from segmented views of the joint surfaces, can be a useful diagnostic tool.

The Applicants have developed a method for determining joint spacing of a patient. The method can be executed at least in part by a computer. A 3-D volume image that includes at least bone content and background is accessed. A 3-D bone region is automatically segmented from the 3-D volume image to generate a 3-D bone volume image. The 3-D bone volume image includes a plurality of voxels and at least one joint. From the 3-D bone volume image, a 3-D distance map image of the at least one joint is automatically computed. The method then computes one or more joint spacing parameters of the at least one joint from the 3-D distance map image. After the computation, the one or more joint spacing parameters can be displayed, stored, or transmitted. The 3-D bone region can be, for example, a knee, hand, wrist, or ankle.

FIGS. 2 and 3 show graphs and data that can be generated from a joint space map, and whose characteristics can be evaluated, for example, to assess arthritic disease. More particularly, FIG. 2 shows a graph of surface area of contact.

One or more joint spacing parameters can be displayed in a time series. If drug therapy is employed, the display can be in a time series with drug therapy. Further, if displayed, the one or more joint spacing parameters can be displayed relative to a joint spacing parameter of an average/baseline/typical/standard patient. The average/baseline/typical/standard patient can grouped for example by male/female; age (child, teen, adult), and/or size (small, medium, large).

The method of the present embodiment can also include generating a 3-D mapping of the one or more computed joint space parameters and automatically labeling individual joints. The method can also include automatically connecting at least two components for labeling individual joints.

There can be displayed a 3-D color mapping surface rending of joint space narrowing on top of the bone surface. The method can further include a 3-D interactive segmentation of bones and tracking of joint space narrowing change over time. The user interface may be configured to allow a user to select at least two bones for the automatic computing. The method can be configured to automatically identify a type of bone from the segmented 3-D bone region, and then individually display, store, or transmit the one or more joint spacing parameters for the identified type of bone. The method can be configured to allow a user to select a particular joint from the 3-D volume image for the computing of the joint space parameters.

Applicants have described an apparatus for characterizing a bone joint of a patient, the apparatus comprising: (a) a volume imaging apparatus; (b) a computer in signal communication with the volume imaging apparatus and configured with instructions for: (i) accessing 3-D volume image content that includes the bone joint; (ii) automatically segmenting the bone joint volume image content from background content to define at least a first bone surface and a second bone surface that is spaced apart from and faces the first bone surface; (iii) computing one or more distances between at least a first point on the first bone surface and one or more points on the second bone surfaces; and (iv) displaying at least the first and second bone surfaces, wherein the display appearance is conditioned by the one or more computed distances; and (c) a display for displaying data relating to the one or more computed distances. With such an apparatus, the volume imaging apparatus can be taken from the group consisting of a CT (computed tomography), a CBCT (cone beam computed tomography), and an MRI (magnetic resonance imaging) system.

The method of the present disclosure can also provide a computer storage product having at least one computer storage medium having instructions stored therein causing one or more computers to perform the described calculations and display features.

Consistent with one embodiment, the present invention utilizes a computer program with stored instructions that control system functions for image acquisition and image data processing for image data that is stored and accessed from an electronic memory. As can be appreciated by those skilled in the image processing arts, a computer program of an embodiment of the present invention can be utilized by a suitable, general-purpose computer system, such as a personal computer or workstation that acts as an image processor, when provided with a suitable software program so that the processor operates to acquire, process, transmit, store, and display data as described herein. Many other types of computer systems architectures can be used to execute the computer program of the present invention, including an arrangement of networked processors, for example.

The computer program for performing the method of the present invention may be stored in a computer readable storage medium. This medium may comprise, for example; magnetic storage media such as a magnetic disk such as a hard drive or removable device or magnetic tape; optical storage media such as an optical disc, optical tape, or machine readable optical encoding; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the internet or other network or communication medium. Those skilled in the image data processing arts will further readily recognize that the equivalent of such a computer program product may also be constructed in hardware.

It is noted that the term “memory”, equivalent to “computer-accessible memory” in the context of the present disclosure, can refer to any type of temporary or more enduring data storage workspace used for storing and operating upon image data and accessible to a computer system, including a database. The memory could be non-volatile, using, for example, a long-term storage medium such as magnetic or optical storage. Alternately, the memory could be of a more volatile nature, using an electronic circuit, such as random-access memory (RAM) that is used as a temporary buffer or workspace by a microprocessor or other control logic processor device. Display data, for example, is typically stored in a temporary storage buffer that is directly associated with a display device and is periodically refreshed as needed in order to provide displayed data. This temporary storage buffer can also be considered to be a memory, as the term is used in the present disclosure. Memory is also used as the data workspace for executing and storing intermediate and final results of calculations and other processing. Computer-accessible memory can be volatile, non-volatile, or a hybrid combination of volatile and non-volatile types.

It is understood that the computer program product of the present invention may make use of various image manipulation algorithms and processes that are well known. It will be further understood that the computer program product embodiment of the present invention may embody algorithms and processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with the computer program product of the present invention, are not specifically shown or described herein and may be selected from such algorithms, systems, hardware, components and elements known in the art.

The invention has been described in detail, and may have been described with particular reference to a suitable or presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for characterizing a bone joint of a patient, the method executed at least in part by a computer, comprising:
accessing 3-D volume image content that includes the bone joint;
automatically segmenting the bone joint volume image content from background content to define at least a first bone surface and a second bone surface that is spaced apart from and faces the first bone surface;
computing one or more distances between at least a first point on the first bone surface and one or more points on the second bone surfaces;
displaying at least the first and second bone surfaces, wherein the display appearance is conditioned by the one or more computed distances; and
displaying, storing, or transmitting data relating to the one or more computed distances.

2. The method of claim 1 further comprising calculating and displaying a pressure value between the first and second bone surfaces according to the one or more computed distances.

3. The method of claim 1 wherein segmenting the bone joint volume comprises identifying cortical bone.

4. The method of claim 1 further comprising computing a volume for spacing between the at least the first and second bone surfaces.

5. The method of claim 4 further comprising displaying the computed volume between the at least the first and second bone surfaces using color to represent either distance or pressure for locations within the displayed volume.

6. The method of claim 1 further comprising calculating a contact area for the joint according to the one or more computed distances and a predetermined threshold distance.

7. The method of claim 1 wherein displaying at least the first and second bone surfaces comprises displaying an unfolded view that shows the first and second bone surfaces that face each other within the joint.

8. The method of claim 1 further comprising generating a 2D mapping that shows the computed distance spacing between the first and second bone surfaces.

9. The method of claim 1 further comprising displaying a calculated smoothness or roughness value for one or more bone surfaces of the joint.

10. The method of claim 1 further comprising calculating and displaying a bone density value for bone material lying near the joint.

11. The method of claim 1 further comprising displaying one or more values relating to trabecular bone structure.

12. The method of claim 1 further comprising displaying data related to computed distances for two or more exams taken at different times, wherein displaying the data comprises displaying a volume of the spacing between bones of the bone joint for each of the two or more exams.

13. The method of claim 1 further comprising displaying displaying data related to computed distances for both weight-bearing and non-weight bearing conditions of the bone joint.

14. A method for determining joint spacing of a patient, the method executed at least in part by a computer, comprising:
a) accessing a 3-D volume image that includes at least bone content and background content;
b) automatically segmenting a 3-D bone region from the 3-D volume image to generate a 3-D bone volume image having a plurality of voxels and at least one joint wherein at least a first bone surface is in proximity to a second bone surface;
c) computing, from the generated 3-D bone volume image, a 3-D distance map of the at least one joint, wherein the 3-D distance map includes distance information between at least portions of the first and second bone surfaces at the joint;
d) computing one or more joint spacing parameters of the at least one joint from the 3-D distance map image; and
e) displaying, storing, or transmitting the one or more joint spacing parameters.

15. The method of claim 14 further including automatically labeling individual joints.

16. The method of claim 14 further including automatically connecting at least two components for labeling individual joints.

17. The method of claim 14 further comprising displaying a 3-D color mapping surface rendering of joint spacing between bones.

18. The method of claim 14 further including: 3-D interactive segmentation of bones and tracking of joint space narrowing change over time.

19. The method of claim 14 wherein accessing the 3-D volume image can be accomplished by CT (computed tomography), CBCT (cone beam computed tomography), and/or MRI (magnetic resonance imaging).

20. The method of claim 14 further comprising allowing a user to select at least two bones for the automatic computing.

21. The method of claim 14 further comprising automatically identifying a type of bone from the segmented 3-D bone region, and then individually displaying, storing, or transmitting the one or more joint spacing parameters.

22. The method of claim 14 further comprising allowing a user to select a particular joint from the 3-D volume image for computing the joint space parameters.

23. The method of claim 14 wherein the joint space parameters include at least one of the following: distance, minimum and maximum distance, mode (distribution), skew of a histogram, standard deviation, contact surface area, and relative surface pressure.

24. The method of claim 14 wherein displaying the one or more joint spacing parameters includes displaying the one or more joint spacing parameters in a time series.

25. The method of claim 14 wherein displaying the one or more joint spacing parameters includes displaying the one or more joint spacing parameters in a time series with drug therapy.

26. The method of claim 14 wherein displaying the one or more joint spacing parameters includes one of the following:
(a) displaying the one or more joint spacing parameters relative to a joint spacing parameter of an average/baseline patient; or
(b) providing a volume display of the gap volume spacing between joint surfaces, without display of the corresponding joint surfaces.
